(19) United States
(12) Patent Application Publication
(10) Pub. No.: US 2004/0202060 A1
(43) Pub. Date: Oct. 14, 2004

(54) DISK FORCE-EJECTION AND FORCE-LOADING DEVICE FOR AN OPTICAL DISK DRIVE

(76) Inventors: Tsung-Jung Kuo, Taipei City (TW); Jui-Chiang Lin, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,984

(22) Filed: Apr. 6, 2004

(30) Foreign Application Priority Data
Apr. 10, 2003 (TW) 092108324

(51) Int. Cl. G11B 17/04

(52) U.S. Cl. 369/30.32; 369/30.28

(57) ABSTRACT

A disk force-ejection and force-loading device for use in an optical disk drive. The optical disk drive includes an active gear of a drive motor for loading and ejecting an optical disk and a housing including a position hole nearby the active gear of the drive mo- tor. The disk force-ejection and force-loading device includes a drive element installed on one end of the disk force-ejection and force-loading device for connecting and driving the active gear of the drive motor via the position hole, a motivity provider for rotating the drive element, and a power provider for providing electric power to the motivity provider.

### BACKGROUND OF INVENTION

1. Field of the Invention

The present invention relates to an optical disk drive system, and more particularly, to a disk force-ejection and force-loading device for use in an optical disk drive.

2. Description of the Prior Art

A slot-in optical disk drive allows users to easily load and eject optical disks. Slot-in optical disk drives can be used in many electric appliances, such as lap-top computers, audio players, optical disk drives for computers, and car CD players. And the conventional slot-in optical disk drive can offer a user-friendly loading and ejecting mechanism.

Please refer to FIG. 1. FIG. 1 is a drawing showing an optical disk 9a loaded into a slot 92 of a slot-in optical disk drive 9b. However, the optical disk 9a may not be ejected from the optical disk drive 9b if the loading mechanism fails, the circuitry of the optical disk drive 9b fails, power of the optical disk drive 9b fails, or the motor of the optical disk drive 9b fails. Under this circumstance, the only way to remove the stuck disk from the drive 9b is to disassemble the optical disk drive 9b and it is very inconvenient. Especially for car-use slot-in optical disk drives, it is also too difficult for common users to disassemble the optical disk drive 9b for removing the optical disk 9a. Thus, there is a need to design a force-ejection mechanism in the slot-in optical disk drive.

### SUMMARY OF INVENTION

It is therefore an objective of the claimed invention to provide a disk force-ejection and force-loading device for ejecting optical disks from an optical disk drive or loading optical disks into the optical disk drive when the loading mechanism fails, the circuit of the optical disk drive fails, power of the optical disk drive fails, or the motor of the optical disk drive fails.

According to the claimed invention, a disk force-ejection and force-loading device for use in an optical disk drive is proposed. The optical disk drive includes an active gear of a drive motor for loading and ejecting an optical disk and a housing including a position hole nearby the active gear of the drive motor. The disk force-ejection and force-loading device includes a drive element installed on one end of the disk force-ejection and force-loading device for connecting and driving the active gear of the drive motor via the position hole, a motivity provider for rotating the drive element, and a power provider for providing electric power to the motivity provider.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a perspective view showing an optical disk loaded into a slot of an optical disk drive.

FIG. 2 and FIG. 3 are perspective views of a disk force-ejection and force-loading device used in an optical disk drive according to the present invention.

FIG. 4 and FIG. 5 are perspective views of an optical disk drive and a disk force-ejection and force-loading device showing examples of the insertion of the disk force-ejection and force-loading device.

FIG. 6 is a diagram illustrating a drive motor and an active gear of the drive motor of the optical disk drive.

FIG. 7 and FIG. 8 are three dimensional relationship diagrams of a drive motor and a transmission gear.

FIG. 9 and FIG. 10 are schematic diagrams of the drive motor and the transmission gear.

FIG. 11 is a schematic diagram of the drive element and the active gear of the drive motor according to FIG. 4.

FIG. 12 is a schematic diagram of the drive element and the active gear of the drive motor according to FIG. 5.

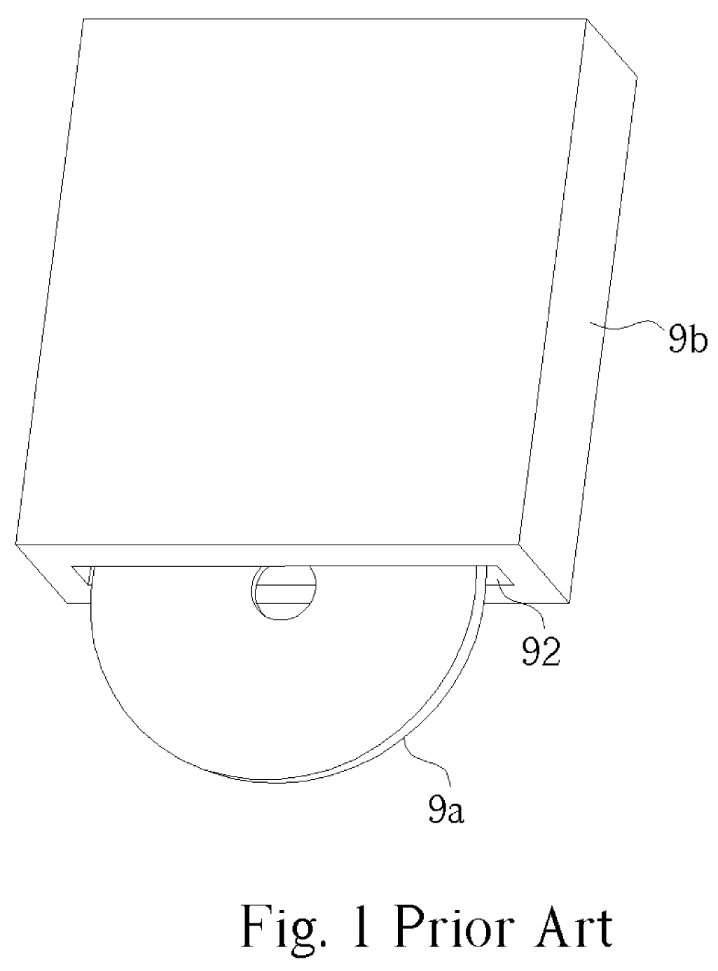

### DETAILED DESCRIPTION

The embodiments according to the present invention are related to a slot-in optical disk drive. In fact, the present invention can be used in all kinds of optical disk drives including CD-ROM, CD-RW, half-height drives, combo drives, DVD-R/RW, external drives, optical players, and so on.

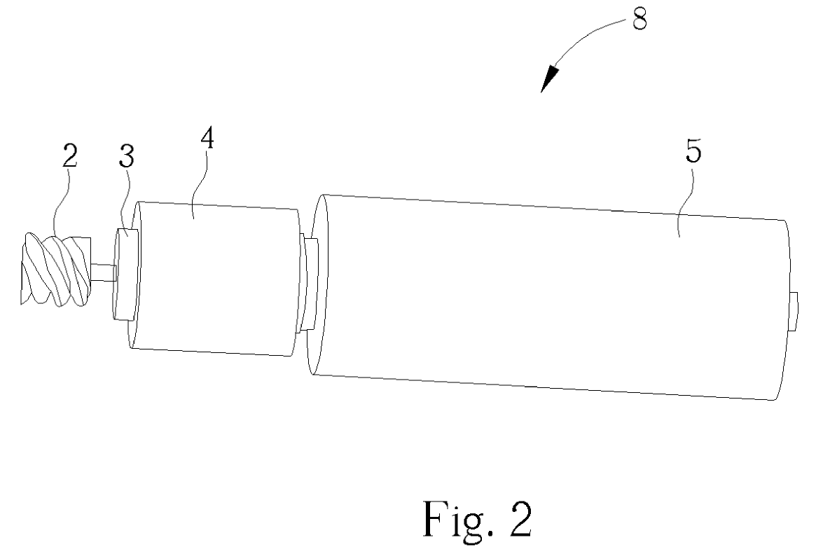

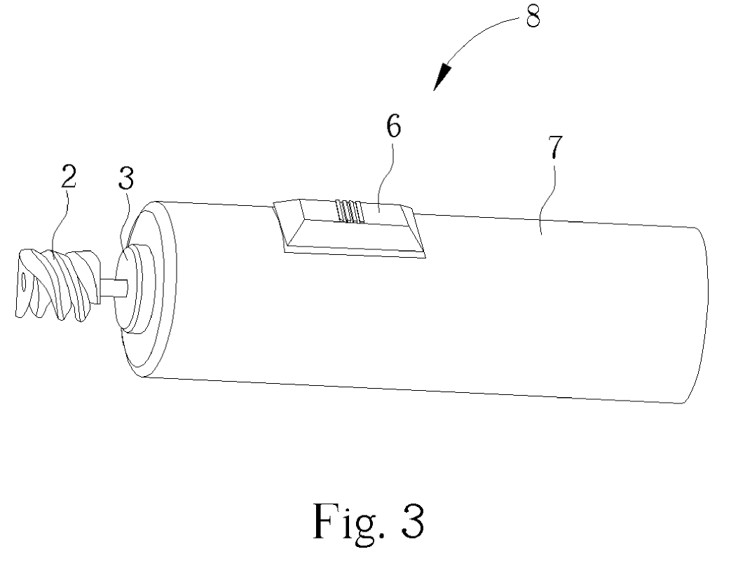

Please refer to FIG. 2 and FIG. 3. FIG. 2 and FIG. 3 show a disk force-ejection and force-loading device 8 used in an optical disk drive according to the present invention. Please refer to FIG. 2. The disk force-ejection and force-loading device 8 includes a drive element 2, a position element 3, a motivity provider 4, and a power provider 5. The drive element 2 is for connecting and driving an active gear of a drive motor of the optical disk drive. The active gear of the drive motor can drive correlative components via a transmission gear to load or eject optical disks. The position element 3 is for fitting into a position hole on a housing of the optical disk drive so as to connect the drive element 2 with the active gear of the drive motor precisely. The power provider 5 provides electric power to the motivity provider 4 to rotate clockwise or counterclockwise so as to drive the drive element 2 to rotate clockwise or counterclockwise. Then the transmission gear can be driven to load or eject optical disks. Please refer to FIG. 3. The disk force-ejection and force-loading device 8 further includes a control switch 6 and an outer covering 7. The control switch 6 is for switching the motivity provider 4 to rotate clockwise or counterclockwise. The outer covering 7 is for covering the motivity provider 4 and the power provider 5.

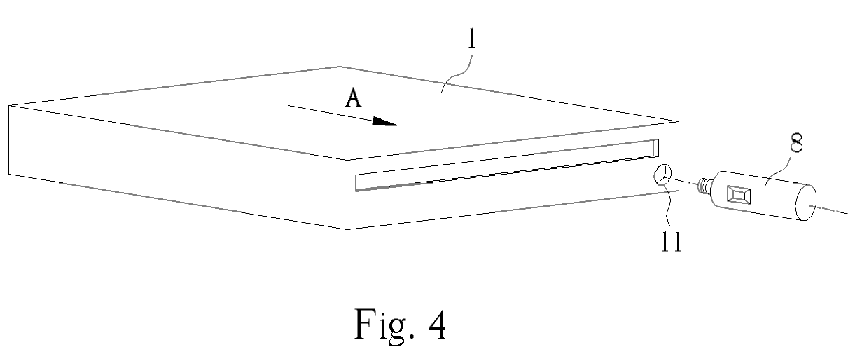

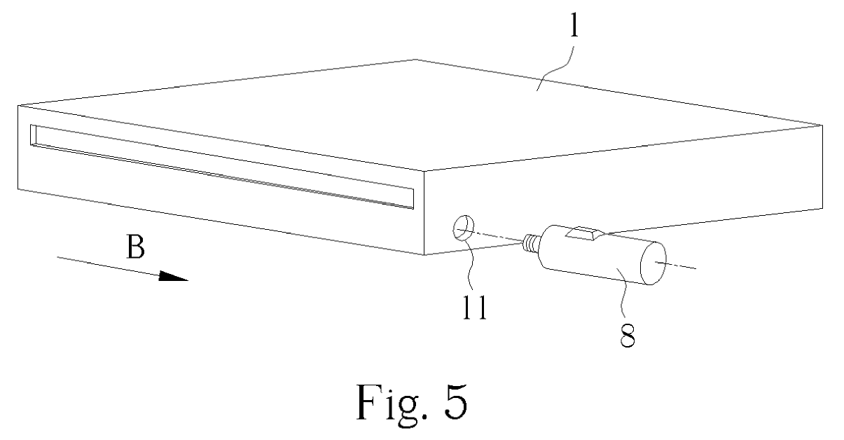

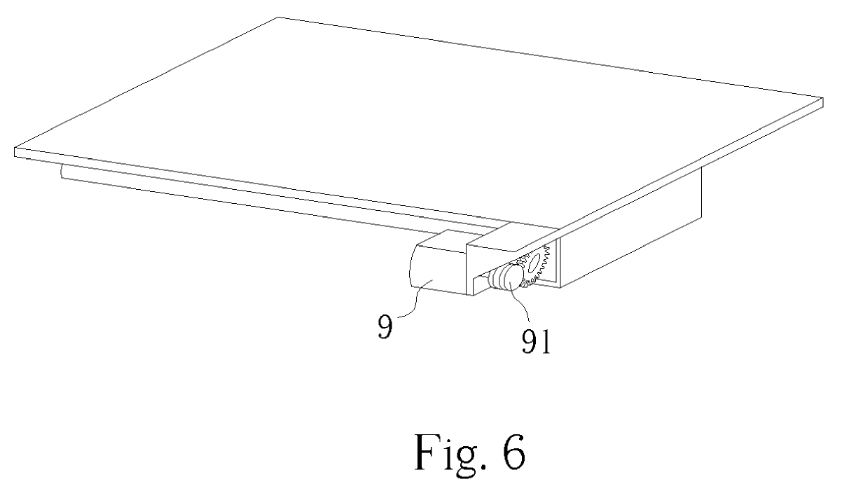

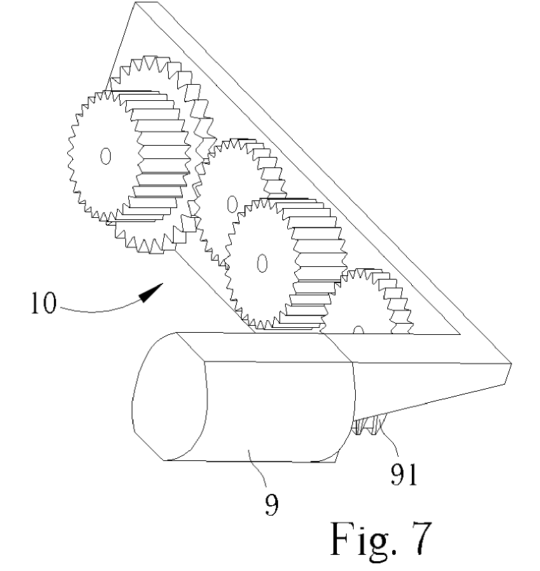

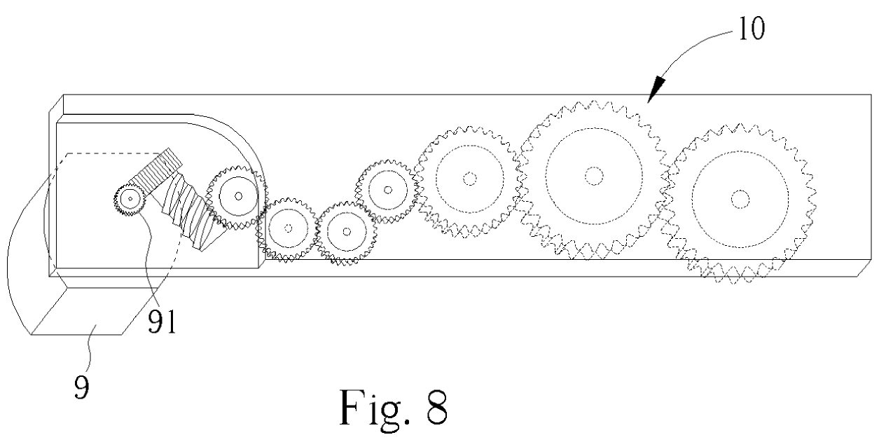

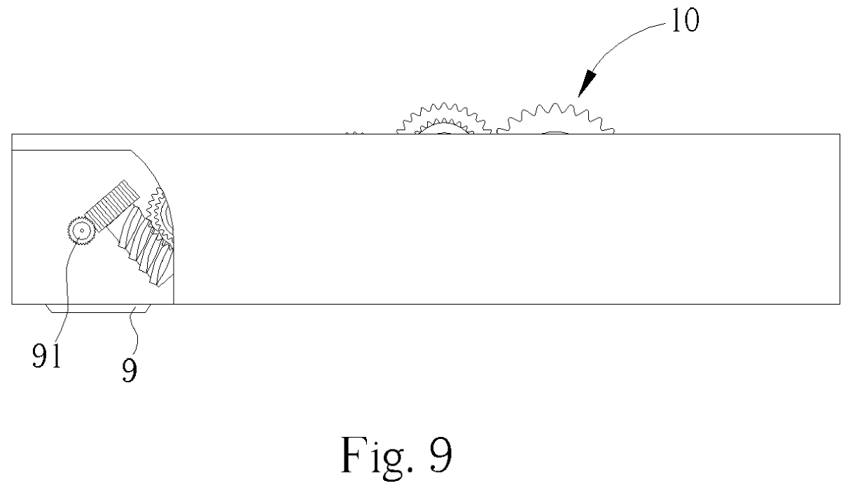

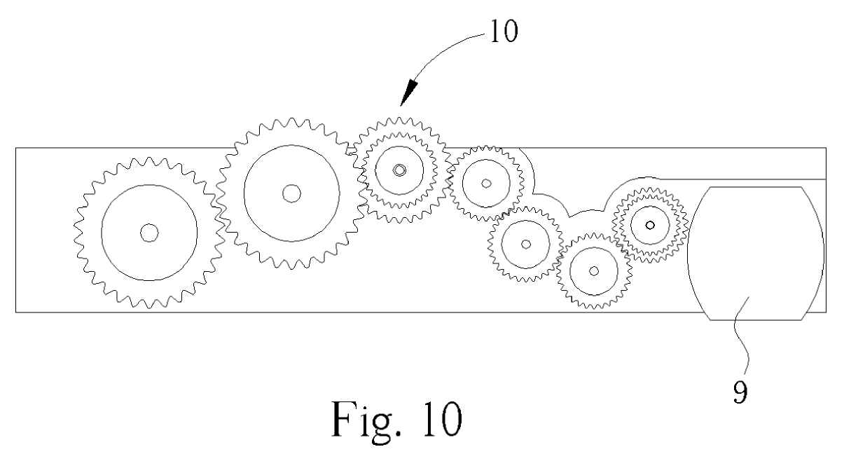

Please refer to FIG. 4 and FIG. 5. FIG. 4 and FIG. 5 show the optical disk drive and the disk force-ejection and force-loading device 8. The optical disk drive includes a housing 1 including a position hole 11 for matching the position element 3 to precisely connect the drive element 2 and the active gear of the drive motor. The disk force-ejection and force-loading device 8 according to present invention can be plugged into the front of the housing 1 (A direction) or the side of the housing 1 (B direction) depending on the design of the position hole 11. In a preferred embodiment, the terminal end of the active gear of the drive motor is toward to the side of the housing 1 (B direction). Please refer to FIG. 6. FIG. 6 illustrates a drive motor 9 and an active gear 91 of the drive motor 9 of the optical disk drive. The drive motor 9 and the active gear 91 of the drive motor 9 are located on a side of the optical disk drive. Please refer to FIG. 7 and FIG. 8. FIG. 7 and FIG. 8 show relationships of the drive motor 9 and a transmission gear 10. Please refer to FIG. 9 and FIG. 10. FIG. 9 and FIG. 10 also show relationships of the drive motor 9 and the transmission gear 10. The active gear 91 of the drive motor 9 can drive the transmission gear 10 to drive related components so as to load or eject an optical disk. The relationship of the drive motor 9 and the transmission gear 10 is changeable and can be designed in accordance with well-know principles.

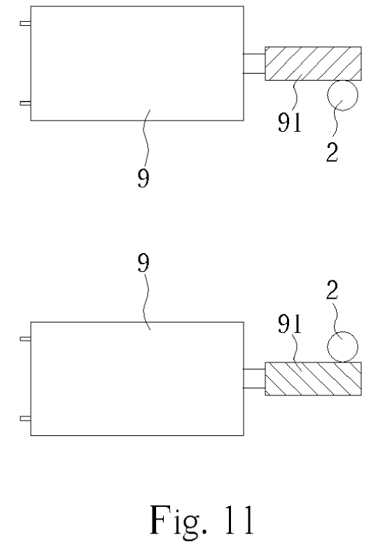

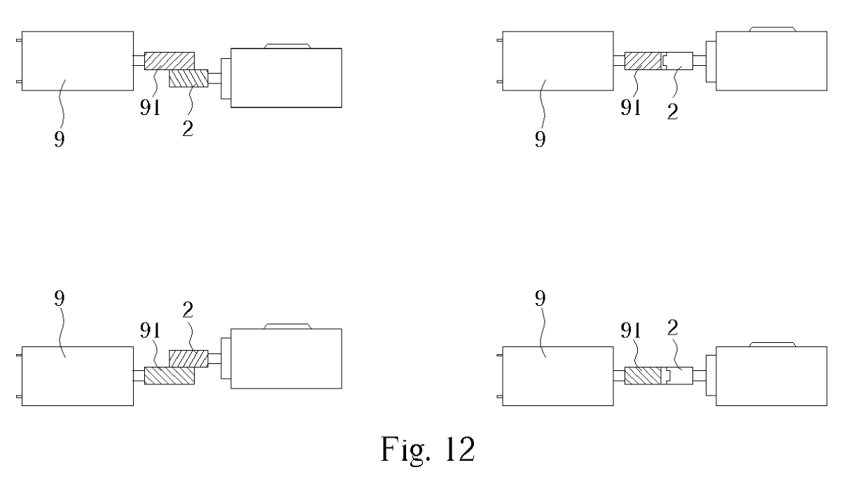

When the optical disk cannot be ejected from the optical disk drive because the loading mechanism fails, the circuit of the optical disk drive fails, power of the optical disk drive fails, or the motor 9 of the optical disk drive fails, the disk force-ejection and force-loading device 8 can be plugged into the position hole 11 according to the present invention. Please refer to FIG. 4. When the position hole 11 is on the front of the housing 1, the disk force-ejection and force-loading device 8 is plugged into the front of the housing 1 (A direction). Please refer to FIG. 11. FIG. 11 shows the relationship of the drive element 2 and the active gear 91 of the drive motor 9 according to FIG. 4. A side of the drive element 2 engages a side of the active gear 91 of the drive motor 9, and the direction of the major axis of the drive element 2 is perpendicular to the direction of the major axis of the active gear 91 of the drive motor 9. The drive element 2 can be above or below the active gear 91. Please refer to FIG. 5. When the position hole 11 is on the side of the housing 1, the disk force-ejection and force-loading device 8 is plugged into the side of the housing 1 (B direction). Please refer to FIG. 12. FIG. 12 shows the relationship of the drive element 2 and the active gear 91 of the drive motor 9 according to FIG. 5. A terminal end of the drive element 2 is connected to a terminal end of the active gear 91 of the drive motor 9. Alternatively, a side of the drive element 2 engages a side of the active gear 91 of the drive motor, and the direction of the major axis of the drive element 2 is parallel to the direction of the major axis of the active gear 91 of the drive motor 9. After the drive element 2 engages the active gear 91 by the connection of the position element 3 and the position hole 11, the power provider 5 can provide electric power to the motivity provider 4 to act according to the control switch 6. Thus the motivity provider 4 can drive the drive element 2, and the drive element 2 can drive the active gear 91 of the drive motor 9 to rotate in a disk-ejection direction. The active gear 91 of the drive motor 9 can drive the transmission gear 10 to drive related components so as to eject an optical disk.

Furthermore, if a user wants to load an optical disk into the optical disk drive when the loading mechanism fails, the circuit of the optical disk drive fails, power of the optical disk drive fails, or the motor 9 of the optical disk drive fails, the disk force-ejection and force-loading device 8 can be plugged into the position hole 11 according to the method previously mentioned. After the drive element 2 engages the active gear 91 by the connection of the position element 3 and the position hole 11, the power provider 5 can provide electric power to the motivity provider 4 to act according to the control switch 6. The motivity provider 4 can drive the drive element 2, and the drive element 2 can drive the active gear 91 of the drive motor 9 to rotate in a disk-loading direction. The active gear 91 of the drive motor 9 can drive the transmission gear 10 to drive the related components so as to load an optical disk.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A disk force-ejection and force-loading device for use in an optical disk drive, the optical disk drive comprising an active gear of a drive motor for loading and ejecting an optical disk and a housing comprising a position hole nearby the active gear of the drive motor, the disk force-ejection and force-loading device comprising:
a drive element installed on one end of the disk force-ejection and force-loading device for connecting and driving the active gear of the drive motor via the position hole;
a motivity provider for rotating the drive element; and
a power provider for providing electric power to the motivity provider.

2. The disk force-ejection and force-loading device of claim 1, wherein the drive element is a gear.

3. The disk force-ejection and force-loading device of claim 1, wherein the motivity provider is a motor.

4. The disk force-ejection and force-loading device of claim 1, wherein the position hole is for matching a position element to connect the drive element and the active gear of the drive motor properly.

5. The disk force-ejection and force-loading device of claim 4, wherein the position element is connected to the motivity provider and positioned between the drive element and the motivity provider.

6. The disk force-ejection and force-loading device of claim 2, wherein a terminal end of the drive element is connected to a terminal end of the active gear of the drive motor, and the position hole is positioned on the housing nearby the terminal end of the active gear of the drive motor.

7. The disk force-ejection and force-loading device of claim 2, wherein a side of the drive element engages a side of the active gear of the drive motor, and the direction of the major axis of the drive element is parallel with the direction of the major axis of the active gear of the drive motor, and the position hole is positioned on the housing nearby the terminal end of the active gear of the drive motor.

8. The disk force-ejection and force-loading device of claim 2, wherein a side of the drive element engages a side of the active gear of the drive motor, and the direction of the major axis of the drive element is perpendicular to the direction of the major axis of the active gear of the drive motor, and the position hole is positioned on the housing nearby the side of the active gear of the drive motor.

9. The disk force-ejection and force-loading device of claim 1, wherein the action modes of the motivity provider comprise a clockwise rotation for driving the drive element to rotate clockwise and a counterclockwise rotation for driving the drive element to rotate counterclockwise.

10. The disk force-ejection and force-loading device of claim 1, wherein the disk force-ejection and force-loading device further comprising:
an outer covering for covering the motivity provider and the power provider; and
a control switch for switching action modes of the motivity provider.

11. The disk force-ejection and force-loading device of claim 10, wherein the power provider is a battery.

12. An optical disk drive comprises:
a drive motor;
an active gear of the drive motor for loading and ejecting
an optical disk; and
a housing comprising a position hole nearby the active gear of the drive motor;
wherein the optical disk drive, a disk force-ejection and force-loading device is used to connect the active gear of the drive motor.

13. The optical disk drive of claim 12, wherein the disk force-ejection and force-loading device comprises:
a drive element installed on one end of the disk force-ejection and force-loading device for connecting and driving the active gear of the drive motor via the position hole;
a motivity provider for rotating the drive element; and
a power provider for providing electric power to the motivity provider.

14. The optical disk drive of claim 13, wherein the drive element is a gear.

15. The optical disk drive of claim 13, wherein the motivity provider is a motor.

16. The optical disk drive of claim 13, wherein the position hole is for matching a position element to connect the drive element and the active gear of the drive motor properly.

17. The optical disk drive of claim 16, wherein the position element is connected to the motivity provider and positioned between the drive element and the motivity provider.

18. The optical disk drive of claim 13, wherein a terminal end of the drive element is connected to a terminal end of the active gear of the drive motor, and the position hole is positioned on the housing nearby the terminal end of the active gear of the drive motor.

19. The optical disk drive of claim 13, wherein a side of the drive element engages a side of the active gear of the drive motor, and the direction of the major axis of the drive element is parallel with the direction of the major axis of the active gear of the drive motor, and the position hole is positioned on the housing nearby the terminal end of the active gear of the drive motor.

20. The optical disk drive of claim 13, wherein a side of the drive element engages a side of the active gear of the drive motor, and the direction of the major axis of the drive element is perpendicular to the direction of the major axis of the active gear of the drive motor, and the position hole is positioned on the housing nearby the side of the active gear of the drive motor.

21. The optical disk drive of claim 13, wherein the disk force-ejection and force-loading device further comprises:
an outer covering for covering the motivity provider and the power provider; and
a control switch for switching action modes of the motivity provider.

22. The optical disk drive of claim 21, wherein the power provider is a battery.
